(19) United States
(12) Patent Application Publication
(10) Pub. No.: US 2018/0238126 A1
(43) Pub. Date: Aug. 23, 2018

(54) BAR AND INSERT FOR RESTRAINING ELONGATED MEMBERS

(71) Applicant: Agile Equipment, LLC, Dallas, TX (US)

(72) Inventor: David Stultz, Odessa, TX (US)

(73) Assignee: Agile Equipment, LLC, Dallas, TX (US)

(21) Appl. No.: 15/588,071

(22) Filed: May 5, 2017

Related U.S. Application Data
(60) Provisional application No. 62/460,794, filed on Feb. 18, 2017.

(51) Int. Cl. E21B 19/15; B65G 1/04

(52) U.S. Cl. CPC E21B 19/15; E21B 19/14; B65G 1/0442

(57) ABSTRACT

A system for restraining movements of elongated members is provided. The system includes a bar and one or more inserts. The bar has a body with a first surface configured to hold elongated members. The body has a plurality of holes disposed in the first surface. The one or more inserts are configured for removable placement in the plurality of holes. The one or more inserts restraining movement of the elongated member longitudinally along the bar. The one or more inserts have a lower portion and an upper portion. The lower portion has the same shape as the plurality of holes. The lower portion is removably insertable into one of the plurality of holes.

### PRIORITY CLAIM

This application claims priority under 35 U.S.C. § 119(e) to U.S. Provisional Application Ser. No. 62/460,794 filed on Feb. 18, 2017. U.S. Provisional Application Ser. No. 62/460,794 is incorporated by reference herein.

### TECHNICAL FIELD

This disclosure is generally directed to oil and gas field technologies. More specifically, this disclosure is directed to a bar an insert for restraining elongated members.

### BACKGROUND

On every well site when drilling stages are nearing completion, casing tubing is shipped out to location and stored until it is time to run it down hole. When casing is brought out it is stacked two to four layers high on top of each other to limit the footprint. A variety of problems arise from the handling of such casing.

### BRIEF DESCRIPTION OF THE DRAWINGS

For a more complete understanding of this disclosure and its features, reference is now made to the following description, taken in conjunction with the accompanying drawings, in which:

FIGS. 1A-1B illustrate conventional practices of placing pipe chock on scrap wood;

FIG. 1C shows one option one has to use with nails that are too long, namely inserting a nail only partially into a wood and then bending;

FIG. 1D show the consequences of failing to utilize the alternative shown in FIG. 1C when nails are too long, namely a dangerous protruding through the bottom of the scrap wood;

FIGS. 2A-2B show conventional practices of avoiding the problems illustrated with reference to FIGS. 1A-1D;

FIGS. 3A-3B illustrate a bar with inserts, according to an embodiment of the disclosure;

FIGS. 4A and 4B illustrate a rack that may be used in conjunction with other embodiments of the disclosure;

FIG. 5 shows another configuration for a bar, according to an embodiment of the disclosure; and

FIG. 6 shows a configuration of bar of FIGS. 3A and 3B except without a layer.

### SUMMARY OF THE DISCLOSURE

According to an embodiment of the disclosure, a system for restraining movements of elongated members is provided. The system includes a bar and one more inserts. The bar has a body with a first surface configured to hold elongated members. The body has a plurality of holes disposed in the first surface. The one or more inserts are configured for removable placement in the plurality of holes. The one or more inserts restraining movement of the elongated member longitudinally along the bar. The one or more inserts have a lower portion and an upper portion. The lower portion has the same shape as the plurality of holes. The lower portion is removably insertable into one of the plurality of holes.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The phrase “at least one of,” when used with a list of items, means that different combinations of one or more of the listed items may be used, and only one item in the list may be needed. For example, “at least one of: A, B, and C” includes any of the following combinations: A; B; C; A and B; A and C; B and C; and A and B and C. Definitions for certain words and phrases are provided throughout this patent document, those of ordinary skill in the art should understand that in many if not most instances, such definitions apply to prior, as well as future uses of such defined words and phrases.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

It will be understood that well known processes and components have not been described in detail and have been omitted for brevity. Although specific steps, structures, and materials may have been described, the present disclosure may not be limited to these specifics, and others may be substituted as it is well understood by those skilled in the art, and various steps may not necessarily be performed in the sequences shown. Although certain components will be referenced, more, less, or different components may be utilized.

Additionally, although a particular type of tubing will be described with reference to certain embodiments (e.g., namely casing with oilfield technology), it should be expressly understood that other types of tubing or tubular can avail from embodiments of this disclosure such as, but not limited, to irrigation tubing, light poles, telephone poles, and infrastructure piping. Additionally, although certain embodiments will be described with regards to stacked tubing, other structures that are non-tubular in design may also avail from embodiments of the disclosure, including as a non-limiting example, stacking elongated members that are square.

In the oil and gas industry, on every well site when drilling stages are nearing completion, casing tubing is shipped out to location and stored until it is time to run down hole. When such casing arrives, it is stacked two to four layers high on top to limit the footprint. In particular, as casing is being off loaded, the casing is conventionally placed on top of pipe racks. After the first layer is laid down, wooden two-by-fours are placed on top of the bottom layer creating a base to lay a second layer of casing pipe on top. After the second layer is complete the same method is used to stack a third and fourth layer of casing pipe. If a stop is not nailed into the ends of both two-by-fours on both ends of the thirty-foot pipe racks, there is a significant safety hazard of the casing pipe rolling off the rack and crushing anyone standing next to or under it.

The International Association of Drilling Contractors (IADC) and the Occupational Safety and Health Administration (OSHA) have recognized the significant dangers of such rolling pipe and, accordingly, have issued guidelines (1910.176(b) RP54 9.12.3) requiring use of stops, pins, or chocks to keep tubulars and other round equipment from rolling off storage racks. The conventional approach to meeting such guidelines has not worked. More particular, workers sort through scrap wood to identify serviceable scrap wood. Then, the worker locates a hammer, nail and pipe chock (or a wedge). Finally, the worker holds the nail in place with cumbersome gloves while hammering the pipe chock onto the scrap wood. In such a process, workers need to be mindful of the dangers presented by the nail that inevitably pierces the wood. The process is not only inefficient, but also risky.

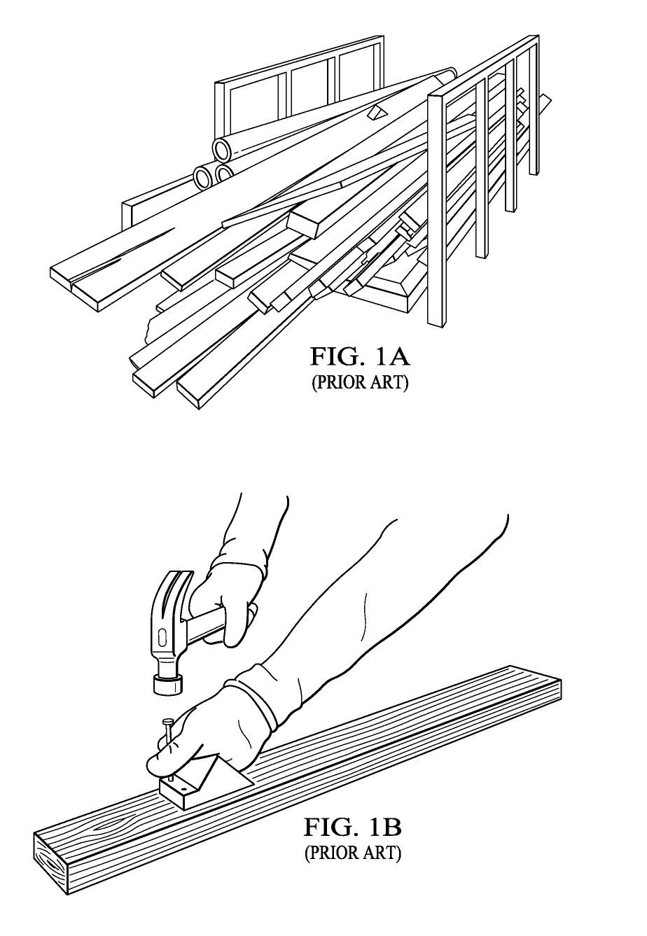

With reference to such conventional practices, FIG. 1A illustrates an often-seen site of scrap wood. FIG. 1B shows the nailing of a pipe chock to the scrap wood. If a hammer cannot be located, one conventionally resorts to using whatever tool (e.g., a wrench) he or she can find to insert the nail through the stopper. Such makeshift tools only increase the safety risk. As yet a further risk, nails that are located are often too long for the width of the scrap wood. FIG. 1C shows one option one has to use with nails that are too long, namely inserting a nail only partially into a wood and then bending. FIG. 1D show the consequences of failing to utilize the alternative shown in FIG. 1C when nails are too long, namely a dangerous protruding through the bottom of the scrap wood.

Not surprisingly, using this conventional approaches, hand and finger injuries consistently trend in the oil and gas industry. Historically, hand and finger injuries make up nearly 50 percent of incidents in the oil and gas industry and at some facilities, that number is closer to 80 percent of all recordable incidents. Hands and fingers have more nerve endings per square centimeter that any part of the human body and more pain receptors than any part of our bodies. As a result, injuries are more painful than similar injuries to other parts of the body.

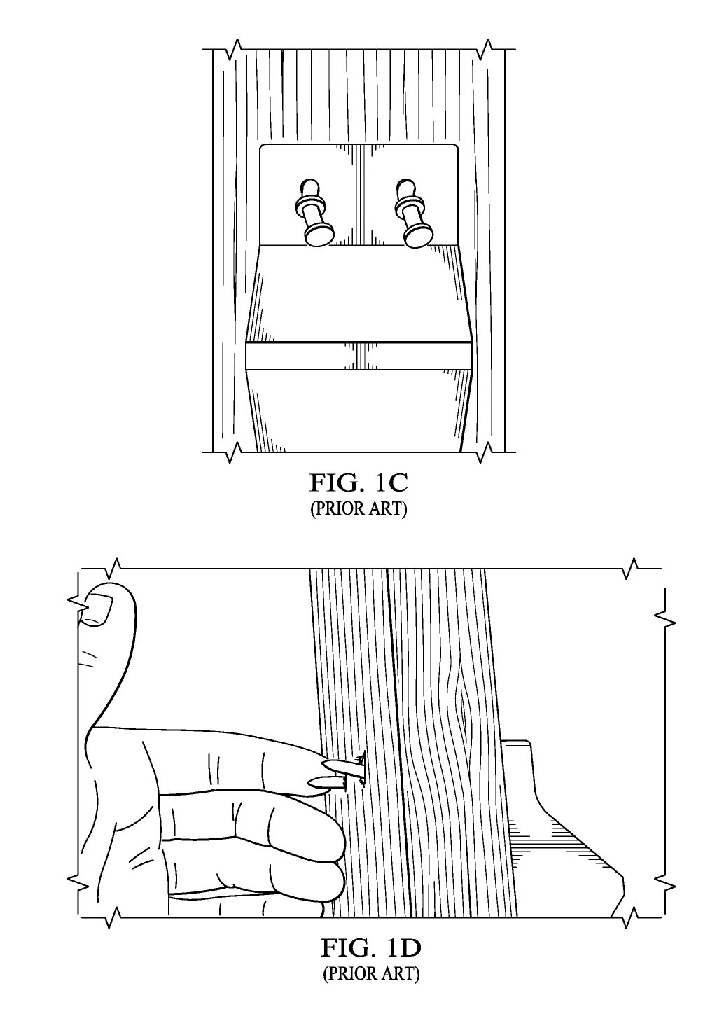

The threat is so obvious and pervasive that workers routinely improvise in the field to avoid using pipe chock, seeking other (non-OSHA compliant) alternatives to keep tubulars in place, such as using scrap wood, pipe threaders, rocks or other objects that can be wedged between the pipe to hold it in place, for example as illustrated with reference to FIGS. 2A and 2B.

A variety of other problems arise with the conventional techniques used in stacking such casing. In particular, the wood between layers eventually rots, cracks, or breaks due to weight of the casing or poor handling and storage. Moreover, when one needs to reuse a chock nailed to a wooden two-by-four, much effort goes into removing the nails. And, the just used wooden two-by-four after many processes of nailing and removal becomes unserviceable.

Certain embodiments of the disclosure alleviate one or more of the afore-mentioned problems by supplementing or replacing the current wooden two-by-four design, reducing safety concerns in implementing OSHA and IADC guidelines, and increasing a more efficient way to use a new pipe chock.

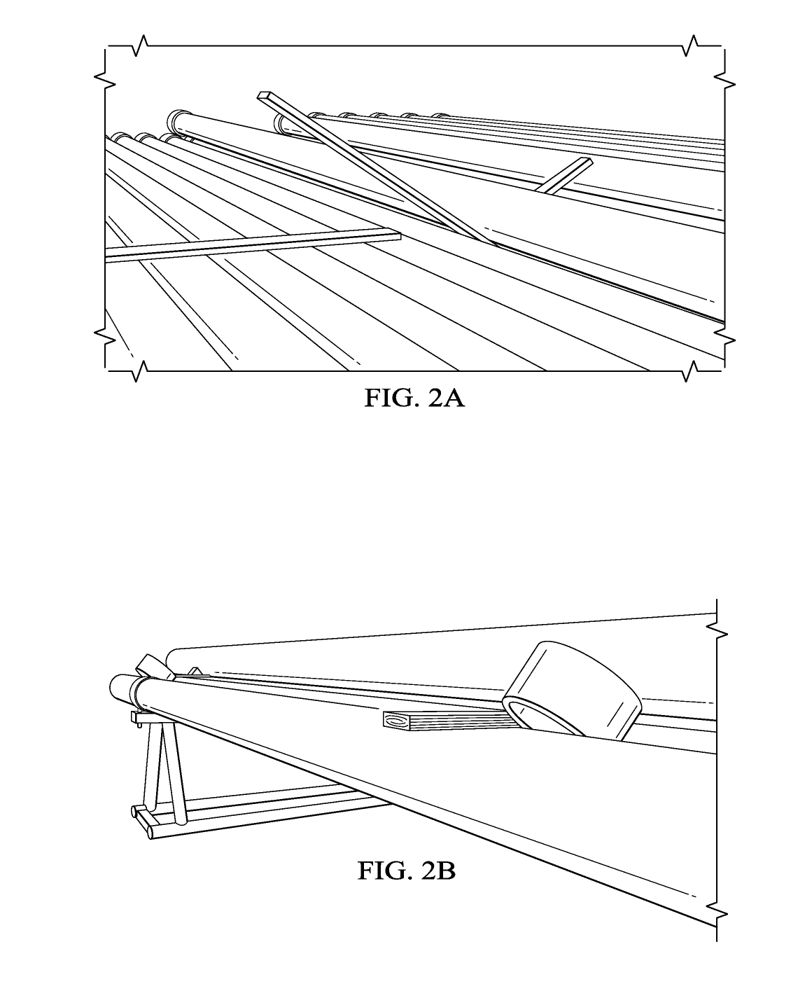

FIGS. 3A-3B illustrate a bar 300 with pipe stopper inserts or inserts 400, according to an embodiment of the disclosure. FIG. 3A shows an overall view of the bar 300 and inserts 400 whereas FIG. 3B shows a zoomed-in portion of FIG. 3A to illustrate additional details. The bar 300 may be placed in-between respective layers of casing or tubing in the same place conventional traditional wooden two-by-fours are placed in order to support the aforementioned stacking.

The bar 300 in FIGS. 3A and 3B is shown with a body 310, holes 320, a layer 330, and one or more straps 340. Although shown with a particular length in FIG. 3A, the length of the bar 300 may vary according to need.

The body 310 may be made of any of a variety of materials or a combination of materials. As a non-limiting example, the body 310 may be made of recycled polyethylene. However, other materials, including other plastics, may be utilized. The body has a first surface that can be seen from the perspective of FIG. 3A. The body also has a second surface opposite the first surface that cannot be seen from the perspective of FIG. 3A. In particular configurations, both the first surface and the second surface can interchangeably be used to support an elongated member.

In particular configurations, the body 310 may be coated with a slip resistant material. This slip resistant material is shown in FIG. 3A as the layer 330. Any of a variety of materials may be utilized that operatively resists movement of an elongated member along its surface. In particular, configurations, such a slip-resistant material may depend on the particular elongated members being stored or stacked. As referenced above, embodiments of the disclosure can be used for different types of elongated members, including metallic and plastic elongated members.

In particular configurations, the layer 330 may be removable. As a non-limiting example, one may replace the layer 330 as necessary to accommodate for wear and/or tear and, also, to accommodate for different types of elongated members. As a non-limiting example of a such a removability, the layer 330 may be a tape with adhesive on one side and a surface that frictionally resists movement of the tubing on other side. As debris builds up, on the layer 330, it can be removed and replaced with additional tape. Yet other configurations for removable layer 330 will become apparent to one of ordinary skill in the art after reviewing this specification. In other configurations, the layer 330 may not be removable. In particular configurations, the layer 330 may only be on a first surface of the body 310 whereas in other configurations, the layer may 330 may also be on the second surface of the body 310. In yet other configurations, the body 310 includes no layer on either the first surface or the second surface.

The holes 320 are generally configured to removably receive the inserts 400 (discussed more below). The holes 320 may be inserted at either regular or irregular intervals along the length of the bar 300 in the first surface. As a non-limiting example, the holes 320 may be inserted every six inches. In other configurations, spacing configurations of other than six inches may be used. In particular configurations, the holes 320 may be machined into the body 310. In other configurations, the holes 320 may be the result of a molding process, for example, in plastic molds.

In the embodiment of FIGS. 3A and 3B, the hole 320 is shown extending from the first surface all the way through to the second surface on the opposite side. Accordingly, removable insertion of the inserts 400 may occur from either the side of the first or the side of the second surface.

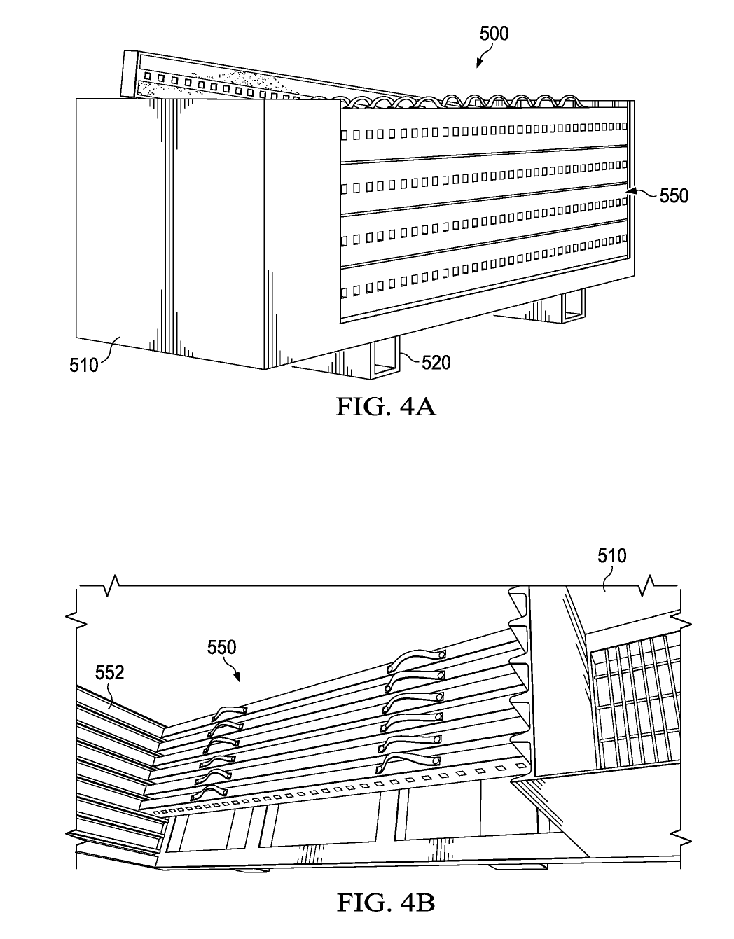

The holes 320 may take on a variety of configurations. In FIGS. 3A and 3B, when viewed from plane of the first surface (the plane of the sheet), the holes 320 have a square configuration. Such a square configuration in particular embodiments prevents a rotation of the insert 410 as described more fully below. Although a square hole 320 is shown in this configuration, other hole shapes may be used such a triangles, circles, and the like. As a non-limiting example, FIG. 5 shows an example of a circular hole. Additionally, other shapes can be utilized.

The insert 400 is generally shown as having a lower portion 410 and an upper portion 420. Both the lower portion 410 and the upper portion 420 may be made of a variety of materials that are either the same or different. In the configuration of FIGS. 3A and 3B, the lower portion 410 is a made of steel and has a square shape (when viewed from a cross-section) that compliments the hole 320. The lower portion 410 allows an easy placement and removal of the insert 400 into the hole 320 such that, for example, one needs no tools for either placement or removal.

In the configuration of FIGS. 3A and 3B, the upper portion 420 is a made of high-density polyethylene (HDPE). In other configurations, the upper portion 420 may be made of other materials, including plastics and non-plastics. The upper portion 420 has a first part 424 with a general square configuration and a second part 422 with a triangular configuration. However, the upper portion may take on other configurations as well.

In the configuration of FIGS. 3A and 3B, the engagement of the lower portion 410 into the hole 320 restricts general movement therebetween. That is, viewed from an x, y, and z-axis coordinates with the z-axis going into the hole 320, there is no rotation around the x, y, or x-axis. Like-wise, there is no movement in either direction of the x or y-axis. Rather, a limited single degree of freedom is allowed along the z-axis for insertion and removal of the insert 400 into holes of the board. The hole 320 and lower portion 410 can take on other configurations to allow a limited single degree of freedom. For example, a hexagonal shaped hole 320 and corresponding hexagonal shaped hexagonal shaped lower portion 410 would also limit movement only along the z-axis.

In certain configurations, it may be desirable to have a feature that resists removability of the lower portion 410 from the hole 320 without for example, some action being taken. As a non-limited example, one or both of the lower portion 410 and/or hole 320 may include a mechanism that locks the lower portion 410 when engaged in the hole 320. A push of a of a button on the insert 400 may release the lower portion 410 from the hole. A variety of mechanisms should become apparent to one of ordinary skill in the art including, for example push button latches.

While limited degree of freedom movement is described in the configuration of FIGS. 3A and 3B, other configurations might desire other movement of either the insert 400, the tubular members with which the insert 400 interacts, or both. As a non-limiting example, with reference to the same x, y, and z-coordinate system and defining the x-axis along the bar 300 (longitudinal direction), one may desire to allow movement of a tubular member along the y-axis or transverse to the bar 300. To accomplish this, the insert 400 may be configured to rotate around the z-axis. Or, alternatively, a face of the first part 424 and/or second part 422 can be configured to allow such movement. As a non-limiting example, rotatable bearings arrangement can be used as between the lower portion 410 and hole 320. Or, a rotatable bearing can be placed in a face of the first part 424 and/or second part 422.

Similarly, in certain configurations, it may desirable for limited longitudinal movement of at least a portion of the insert along the x-axis. As a non-limiting example, a portion of the insert may push outward towards an elongated member in a biased manner such that when the elongated member is positioned between respective inserts, the elongated member is sandwiched therebetween. Two respective biasing members push on either side of the elongated member in opposite direction against the elongated member. The biasing member used in such a configuration can be, but is not limited to, a compression spring.

While insert 400 is shown as having a particular width with respect to the bar 300, the insert 400 in other configurations may have a wider or narrower width. Additionally, in particular configurations, a single insert may have more than one lower portion 410 that fills more than one hole. For example, two holes 320 may be positioned next to one another transversely (along the y-axis). Alternatively, in other configurations, a single insert 400 with multiple lower portions 410 may be positioned across multiple bars 300.

One or more straps 340 may be positioned to allow easy movement of the bar 300.

Although inserts are shown as being positioned in the holes 320 of the bar, in other configurations any of variety of items may be placed within the holes 320. As a first example, connecting pieces may be placed in the holes 320. More particularly, for example, a piece with a lip that allows partial insertion into the hole 320 may be inserted to allow the transverse placement of another bar 300 on top. Such a configuration can repeated as necessary to get a desired connection of different bars. As a second example, special pieces may be inserted for certain desired purposes.

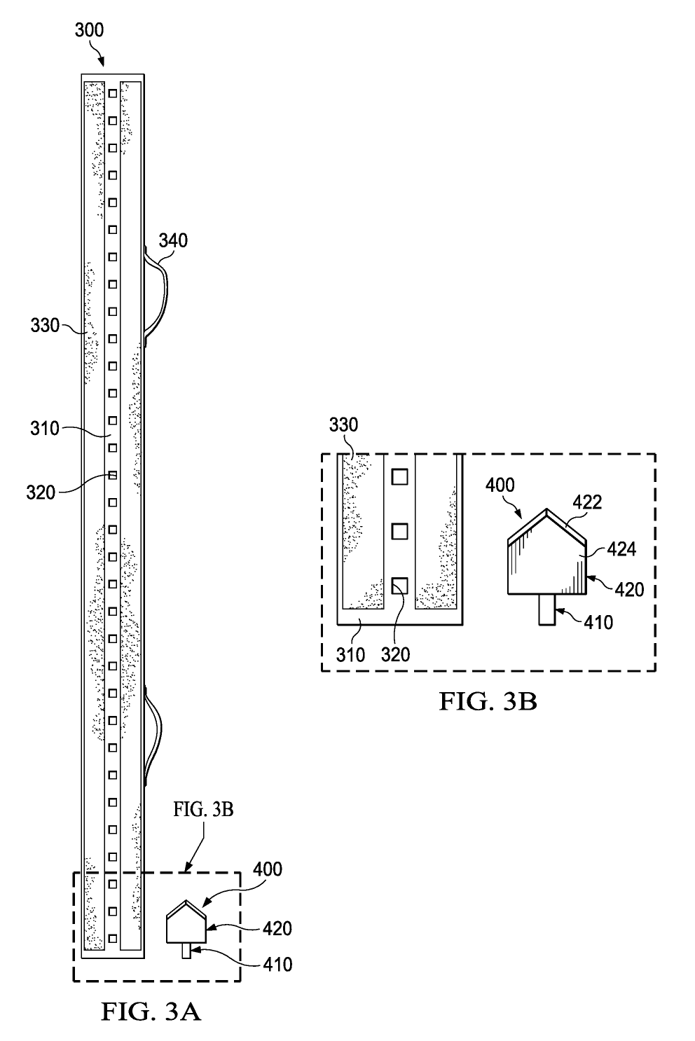

FIGS. 4A and 4B illustrate a rack 500 that may be used in conjunction with other embodiments of the disclosure.

FIG. 4A shows a perspective view of the rack 500 with a first portion 510 for holding inserts 400 and a second portion for 550 for holding bars 300. The rack 500 is shown positioned upon blocks 520; however, in other configurations, the racks may have other supports, including those with wheels to allow a movement of the rack.

FIG. 4B shows that the second portion 550 includes grooves 552 that arrange the bars 300 with respect to one another and allow a stacking, for example, as seen with reference to FIG. 4A.

FIG. 4B also show the first portion 510 as a container with a grated bottom that allows storage of inserts 400.

FIG. 5 shows another configuration for a bar 600, according to an embodiment of the disclosure. The bar 600 is similar in design to the bar 300 of FIGS. 3A and 3B except that it has circular holes 620 and lacks a layer (e.g., layer 330). The bar 600 with insert 700 is shown supporting an elongated member 1000. As the holes in particular configurations extend through the bar, one can see with reference to FIG. 5, how one could also place an insert on the second side of the bar to position it with respect to underlying layers. Specifically, with reference to terminology introduced earlier, one may place an insert on both a first surface to engage with a layer above the bar and a second surface opposite surface to engage with a layer below.

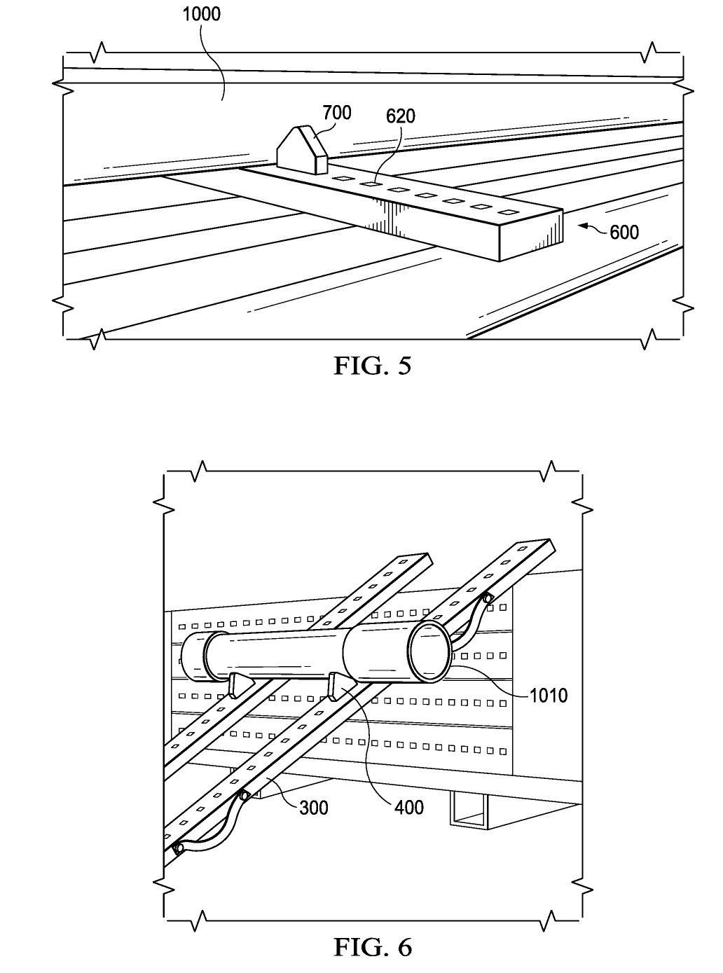

FIG. 6 shows a configuration of bar 300 of FIGS. 3A and 3B except without a layer 330. The bar 300 with insert 400 is shown supporting an elongated member 1010.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A system for restraining movements of elongated members, the system comprising:
a bar with a body having a first surface configured to hold at least one elongated tubular member, wherein the body has a plurality of holes disposed in the first surface; and
one or more inserts configured for removable placement in the plurality of holes, the one or more inserts vertically extending, from the first surface, only a portion of a diameter of the at least one tubular member, the one or more inserts restraining a rolling movement of the elongated tubular member.

2. The system of claim 1, wherein the one or more inserts include an angled portion that abuts against a portion of the surface of the at least one tubular member.

3. The system of claim 1, wherein:
the one or more inserts have a lower portion and an upper portion,
the upper portion includes an angled portion that abuts against a portion of the surface of the at least one tubular member,
the lower portion has the same shape as the plurality of holes, and
the lower portion is removably insertable into one of the plurality of holes.

4. The system of claim 3, wherein:
the lower portion comprises metal, and
the upper portion comprises plastic.

5. The system of claim 2, wherein:
the only degree of freedom as between the one or more inserts and the bar is an insertion and removal of the one or more inserts.

6. The system of claim 1, wherein the bar is made of plastic.

7. The system of claim 1, wherein the plurality of holes are shaped substantially as a square when viewed from a plane of the first surface.

8. The system of claim 1, wherein the plurality of holes are shaped substantially as a circle when viewed from a plane of the first surface.

9. The system of claim 1, wherein the bar has a second surface opposite the first surface, and the plurality of holes extend from the first surface to the second surface.

10. The system of claim 1, wherein
the bar has a second surface opposite the first surface, and
the second surface is also configured to hold at least one elongated tubular member such that the bar can interchangeably allow either the second surface or the first surface support the at least one elongated tubular member.

11. The system of claim 1, further comprising:
a layer disposed on the first surface, the layer configured to frictionally resist movement of the elongated members.

12. The system of claim 11, wherein the layer is removable.

13. A system for restraining movements of elongated members, the system comprising:
a bar with a body having a first surface configured to hold at least one elongated tubular member, the body having a plurality of holes disposed in the first surface;
one or more inserts configured for removable placement in the plurality of holes, the one or more inserts vertically extending, from the first surface, only a portion of a diameter of the at least one tubular member, the one or more inserts restraining a rolling movement of the elongated member along the bar, wherein
the one or more inserts have a lower portion and an upper portion,
the lower portion has the same shape as the plurality of holes, and
the lower portion is removably insertable into one of the plurality of holes.

14. The system of claim 13, wherein:
the lower portion comprises metal, and
the upper portion comprises plastic.

15. The system of claim 13, wherein:
the only degree of freedom as between the one or more inserts and the bar is an insertion and removal of the one or more inserts.

16. The system of claim 13, wherein the bar is made of plastic.

17. The system of claim 13, wherein the plurality of holes are shaped substantially as a square when viewed from a plane of the first surface.

18. The system of claim 13, wherein the plurality of holes are shaped substantially as a circle when viewed from a plane of the first surface.

19. The system of claim 13, wherein the bar has a second surface opposite the first surface, and the plurality of holes extend from the first surface to the second surface.

20. The system of claim 13, wherein
the bar has a second surface opposite the first surface, and
the second surface is also configured to hold at leas one elongated tubular member such that the bar can interchangeably allow either the second surface or the first surface to support the at least one elongated tubular member.

21. The system of claim 13, further comprising:
a layer disposed on the first surface, the layer configured to frictionally resist movement of the elongated members.

22. The system of claim 11, wherein the layer is removable.

23. A system for restraining movements of elongated members, the system comprising:
a bar with a body having a first surface a second surface, the second surface opposite the side of the first service, the first surface and the second surface configured to hold elongated members such that the bar can interchangeably allow either the second surface or the first surface to support the elongated members, wherein the body has a plurality of holes disposed in the first surface that extend to the second surface; and
one or more inserts configured for removable placement in the plurality of holes, wherein
the one or more inserts restraining movement of the elongated member longitudinally along the bar,
the one or more inserts having an angled portion extending at an angle with respect to a plane of the board.

24. The system of claim 23, wherein the elongated member is tubular and the angled portion abuts against a portion fo the surface of the at least one tubular member.

25. The system of claim 23, wherein:
the one or more inserts have a lower portion and an upper portion,
the lower portion has the same shape as the plurality of holes, and
the lower portion is removably insertable into one of the plurality of holes.

26. The system of claim 25, wherein:
the lower portion comprises metal, and
the upper portion comprises plastic.

27. The system of claim 24, wherein:
the only degree of freedom as between the one or more inserts and the bar is an insertion and removal of the one or more inserts.

28. The system of claim 23, wherein the bar is made of plastic.

29. The system of claim 23, wherein the plurality of holes are shaped substantially as a square when viewed from a plane of the first surface.

30. The system of claim 23, wherein the plurality of holes are shaped substantially as a circle when viewed from a plane of the first surface.
